(19) United States
(12) Patent Application Publication
(10) Pub. No.: US 2019/0012648 A1
(43) Pub. Date: Jan. 10, 2019

(54) ASSISTANCE SYSTEMS FOR CASH TRANSACTIONS AND MONEY MANAGEMENT

(71) Applicant: ReAble Inc., Metn District (LB)

(72) Inventors: Emile Sawaya, Beirut (LB); Paul Safi, Beirut (LB)

(21) Appl. No.: 16/030,553

(22) Filed: Jul. 9, 2018

Related U.S. Application Data
(60) Provisional application No. 62/529,995, filed on Jul. 7, 2017.

(51) Int. Cl. G06Q 20/14; G06Q 20/32

(52) U.S. Cl. CPC G06Q 20/145; G06Q 20/3223

(57) ABSTRACT

Assistance systems for cash transactions and money management are provided.

### CROSS-REFERENCE TO RELATED APPLICATIONS

This application claims the benefit of U.S. Provisional Application No. 62/529,995, filed Jul. 7, 2017, the entire contents of which is hereby incorporated by reference.

### BACKGROUND

Embodiments of the present disclosure relate to assistance technologies, and more specifically, to assistance systems and methods for cash transactions and money management.

### BRIEF SUMMARY

According to embodiments of the present disclosure, methods of and computer program products for assisted in-person transactions are provided.

### BRIEF DESCRIPTION OF THE SEVERAL VIEWS OF THE DRAWINGS

FIG. 1 illustrates a system according to embodiments of the present disclosure.

FIGS. 2A-G illustrate exemplary user interactions with systems according to the present disclosure.

FIG. 3 illustrates an exemplary signup screen according to embodiments of the present disclosure.

FIG. 4 illustrates an exemplary wallet balance screen according to embodiments of the present disclosure.

FIG. 5 illustrates an exemplary wallet balance screen according to embodiments of the present disclosure.

FIG. 6 illustrates an exemplary payment instruction screen according to embodiments of the present disclosure.

FIG. 7 illustrates an exemplary transaction history screen according to embodiments of the present disclosure.

FIG. 8 illustrates an exemplary balance information screen according to embodiments of the present disclosure.

FIG. 9 illustrates an exemplary transaction approval screen according to embodiments of the present disclosure.

FIG. 10 illustrates an exemplary purchase information screen according to embodiments of the present disclosure.

FIG. 11 illustrates an exemplary category screen according to embodiments of the present disclosure.

FIG. 12 illustrates an exemplary account creation screen according to embodiments of the present disclosure.

FIG. 13 illustrates an exemplary QR login screen according to embodiments of the present disclosure.

FIG. 14 illustrates an exemplary dependent selection screen according to embodiments of the present disclosure.

FIG. 15 illustrates an exemplary dependent selection screen according to embodiments of the present disclosure.

FIG. 16 illustrates an exemplary dependent selection screen according to embodiments of the present disclosure.

FIG. 17 illustrates an exemplary role selection screen according to embodiments of the present disclosure.

FIG. 18 illustrates an exemplary account creation screen according to embodiments of the present disclosure.

FIG. 19 illustrates an exemplary account creation screen according to embodiments of the present disclosure.

FIG. 20 illustrates an exemplary account creation screen according to embodiments of the present disclosure.

FIG. 21 illustrates an exemplary account creation screen according to embodiments of the present disclosure.

FIG. 22 illustrates an exemplary account creation screen according to embodiments of the present disclosure.

FIG. 23 illustrates an exemplary account creation screen according to embodiments of the present disclosure.

FIG. 24 illustrates an exemplary account creation screen according to embodiments of the present disclosure.

FIG. 25 illustrates an exemplary login screen according to embodiments of the present disclosure.

FIG. 26 illustrates an exemplary wallet balance screen according to embodiments of the present disclosure.

FIG. 27 illustrates an exemplary wallet balance screen according to embodiments of the present disclosure.

FIG. 28 illustrates an exemplary payment screen according to embodiments of the present disclosure.

FIG. 29 illustrates an exemplary payment instruction screen according to embodiments of the present disclosure.

FIG. 30 illustrates an exemplary photo prompt screen according to embodiments of the present disclosure.

FIG. 31 illustrates an exemplary confirmation screen according to embodiments of the present disclosure.

FIG. 32 illustrates an exemplary transaction history screen according to embodiments of the present disclosure.

FIG. 33 illustrates an exemplary settings screen according to embodiments of the present disclosure.

FIG. 34 illustrates an exemplary transaction history screen according to embodiments of the present disclosure.

FIG. 35 illustrates an exemplary transaction information screen according to embodiments of the present disclosure.

FIG. 36 illustrates an exemplary account creation screen according to embodiments of the present disclosure.

FIG. 37 illustrates an exemplary QR login screen according to embodiments of the present disclosure.

FIG. 38 illustrates a method according to embodiments of the present disclosure.

FIG. 39 depicts a computing node according to an embodiment of the present invention.

### DETAILED DESCRIPTION

People with certain intellectual disabilities may struggle with independently managing their finances and transactions. In some cases, this is due to a difficulty in conceptualizing the value of money. This affects the capacity to determine the appropriate combination of bank notes to pay with, and how much change to expect in return.

At present, a parent or guardian of an intellectually disabled individual lacks the tools necessary to effectively track and record details of their dependent's transactions, such as locations, time of transaction, product(s) purchased, and amount spent. This may cause the parent or guardian to be reluctant in allowing a dependent more responsibilities. Special needs educators likewise have a need for more engaging media through which to effectively teach financial literacy and money management.

At present, there are no solutions to the problem of ensuring accurate cash transactions, apart from constant supervision from a responsible third party. One approach for special needs educators to teach money management is the use of fake (or real, but without any actual exchange of value) currencies to practice handling transactions in a safe, one-on-one environment. Traditional cashless payment methods are also taught.

Having a responsible party constantly chaperone a dependent imposes a significant drain on the time and resources of a guardian. Furthermore, it severely limits the opportunities available for a dependent to participate in society.

With regard to cashless transaction education, there is a risk of individuals spending more than they can afford due to the intersection of underdeveloped value comprehension and the ease of cashless transaction. Although cashless payments may allow individuals with intellectual disabilities to receive a product, and so avoid dealing with an actual cash exchange, this limits the individual's opportunity to conceptualize and comprehend the value of the transaction.

There is at present no effective way to ensure that intellectually disabled individuals are able to seek permission from a guardian to purchase specific products. It is difficult for intellectually disabled individuals to communicate the intention to purchase specific products to their guardian, and at times, may unknowingly want to purchase products which are not appropriate for them. Guardians on the other hand, wish to help the intellectually challenged individual make purchases on their own—provided that the product is appropriate and the price is reasonable. There is no way to ensure that guardians can selectively approve products without having to be there physically. There is also no way to authorize payment for specific in-store purchases without giving access to cash or a credit card (which only have limits on amount spending rather than product purchased).

In addition, there are no banks that cater to the unique needs of the intellectually disabled, making the option of cashless payments even more unrealistic.

In order for individuals to lead independent lives, they must be able to perform financial transactions with reasonable proficiency. The skills taught by special needs educators can be difficult to implement in real-world situations where there is an added degree of stress and unfamiliarity, and the situation can change in unexpected ways that cannot be practiced.

The present disclosure addresses these and other shortcomings of alternative approaches by providing mobile applications that facilitate cash and cashless transactions.

According to various embodiments of the present disclosure, systems and methods are provided, including mobile apps that guide a user through cash transactions by providing all of the information necessary to complete their transaction process correctly. This eliminates the need for a physical chaperone. It allows guardians to be notified in real time of their dependent's cash transactions in an immutable fashion, providing documentation of the transaction's geolocation, time, total cost, product purchased (e.g., by photo) and the category of product purchased from a list provided by the app (such as “food” or “clothing”). The app may be deployed on a variety of mobile platforms, including Android and iPhone.

According to various embodiments of the present disclosure, systems and methods are provided, including mobile apps that facilitates communication of information about a prospective transaction in order to authorize said transaction(s). Authorization of the transaction occurs without sharing access to financial credentials or permitting transactions outside of what is specifically requested. An image of the product(s) for a prospective transaction is taken alongside a price and the current geolocation of the user. The guardian receives a push notification which when opened displays a screen detailing the product(s) image, price, location, and the option to either Approve or Reject a transaction. Elements of the screen can be interacted with to zoom in to the image or location.

Systems embodying the present disclosure provide assistance through simple and easily accessible media that can augment financial skills of a user. In addition, users are able to take the lessons they've learned from their special needs educator, and more easily apply them to the real world. Transparency and accountability between guardian and user are provided, which is achieved by providing real time updates of the user's transactions to the guardian.

In various embodiments, an account can be created by either the user or their guardian. Before leaving the house, the user inputs the bank notes (s)he has in their wallet. Prior to making a purchase, they input the amount due into the app which then gives them an appropriate combination of bills to pay with, along with the amount of change they should receive. The user would then select a category describing their purchase and take a photo. All of this information is then immediately sent to the guardian via a push notification and recorded for both parties. The guardian may also check the transaction history and current balance of the user's wallet at any time.

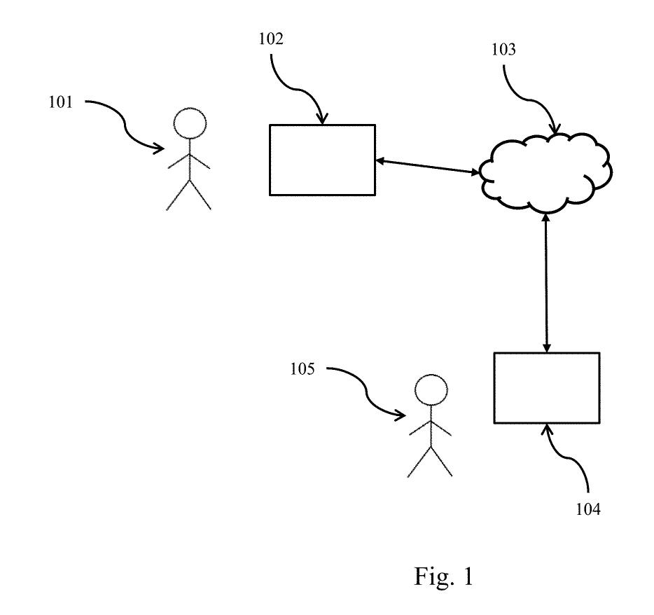

With reference now to FIG. 1, an exemplary system according to embodiments of the present disclosure is illustrated. User 101 interacts with mobile device 102 in the course of an in-person cash transaction. As outlined above, information about the present transaction is entered to the mobile device. An alert is provided via network 103 to a remote mobile device 104. User 105 may review the transaction in progress, and interact in additional ways by, e.g., approving or rejecting the transaction, or providing a message to user 101.

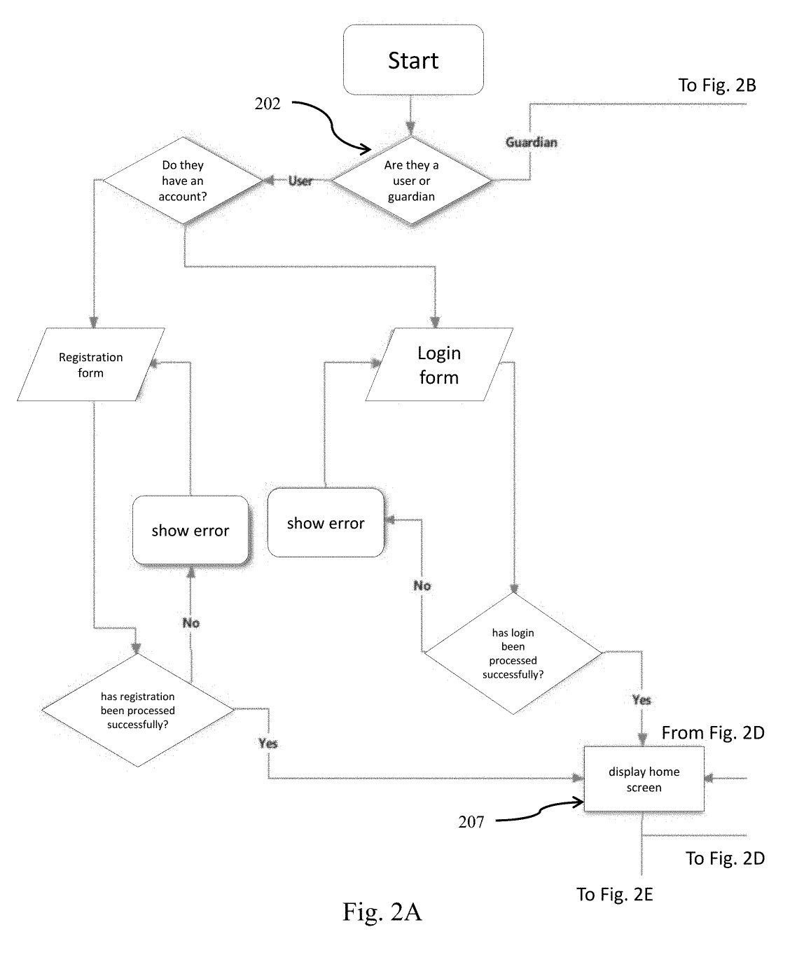

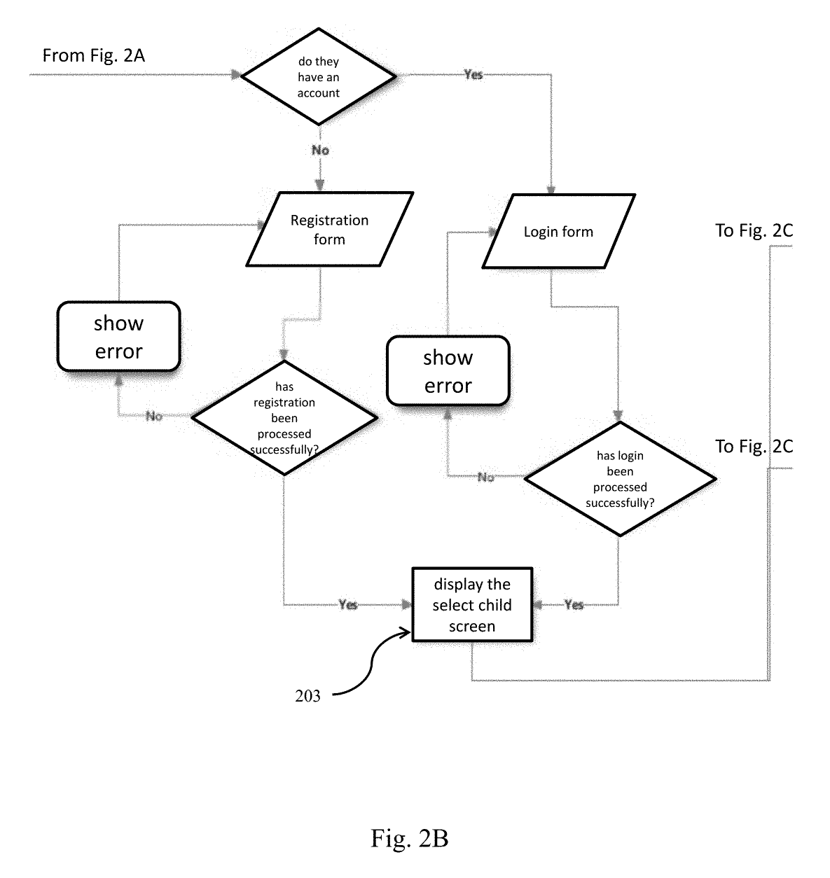

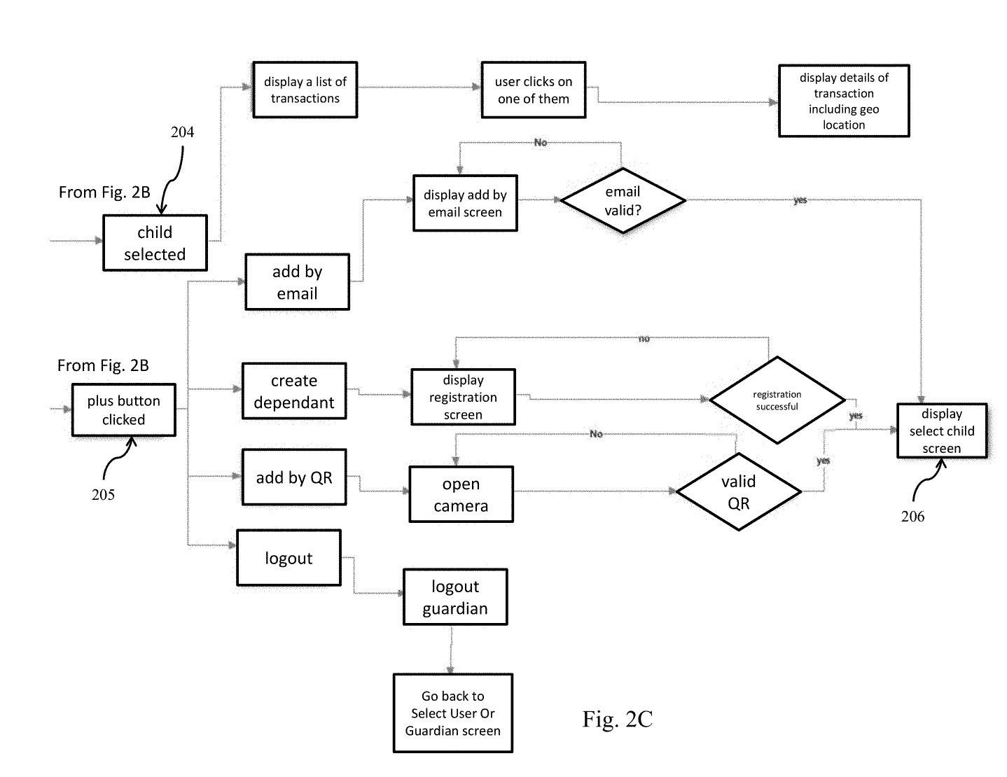

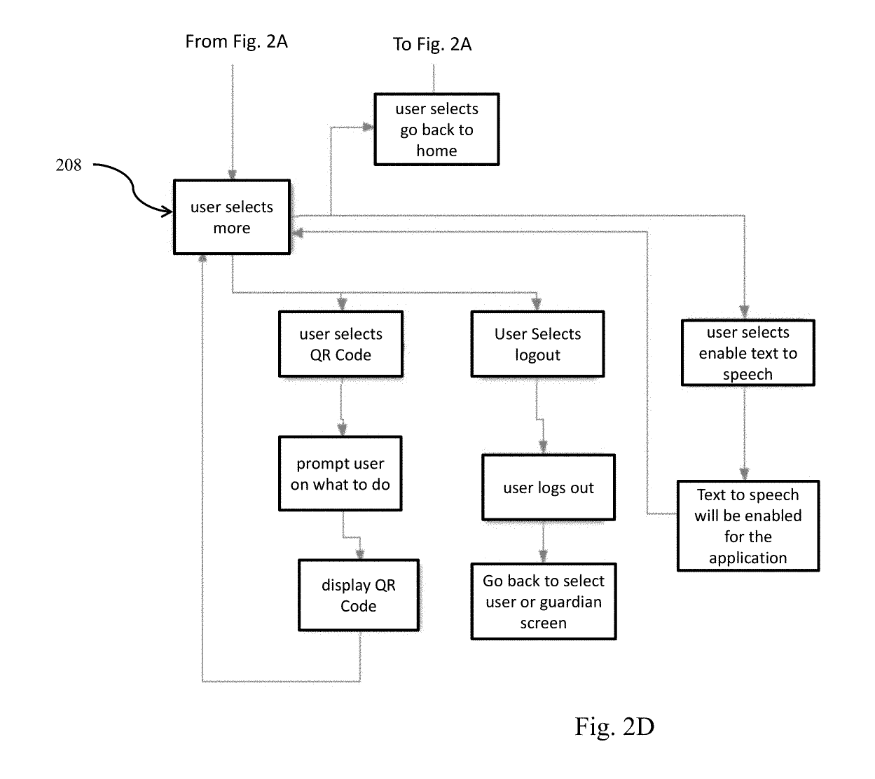

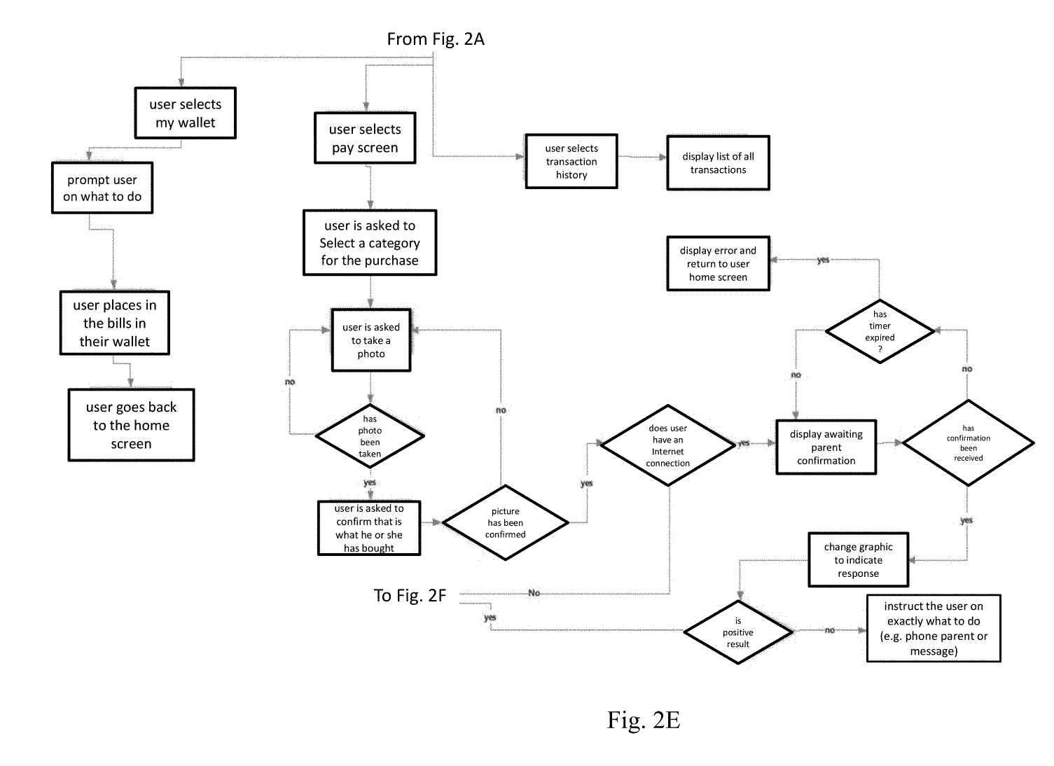

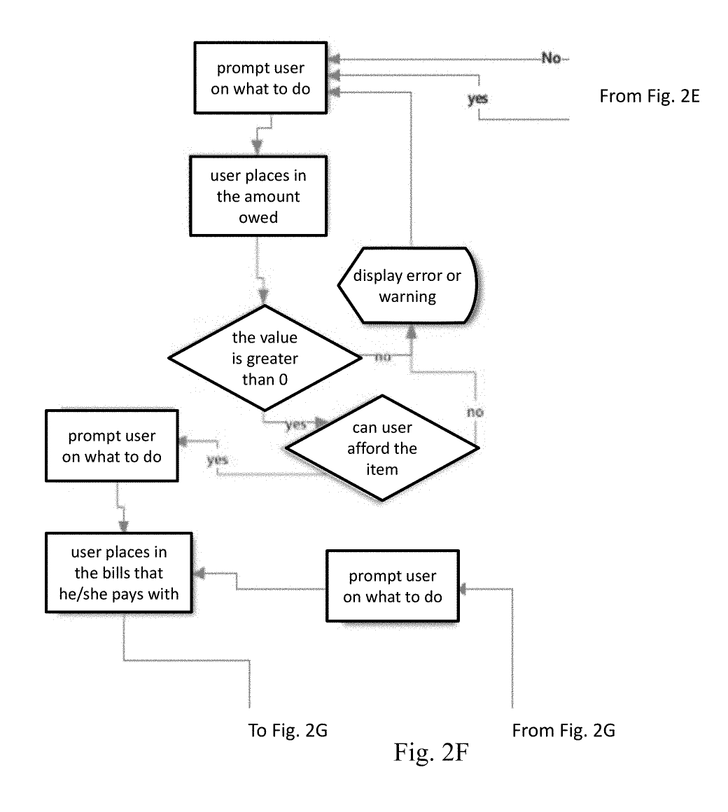

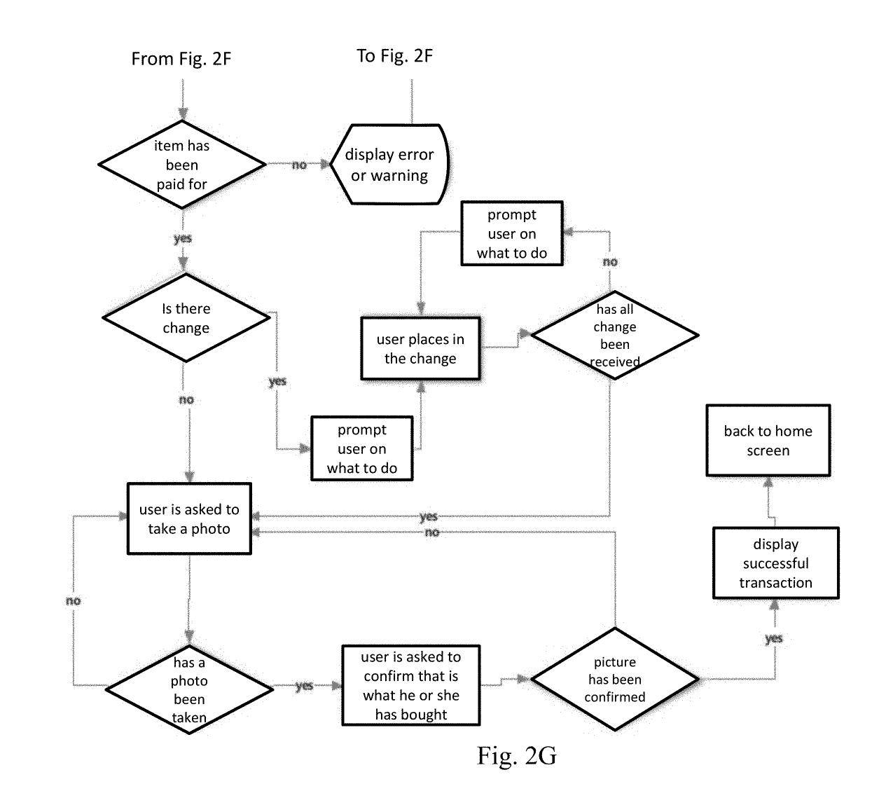

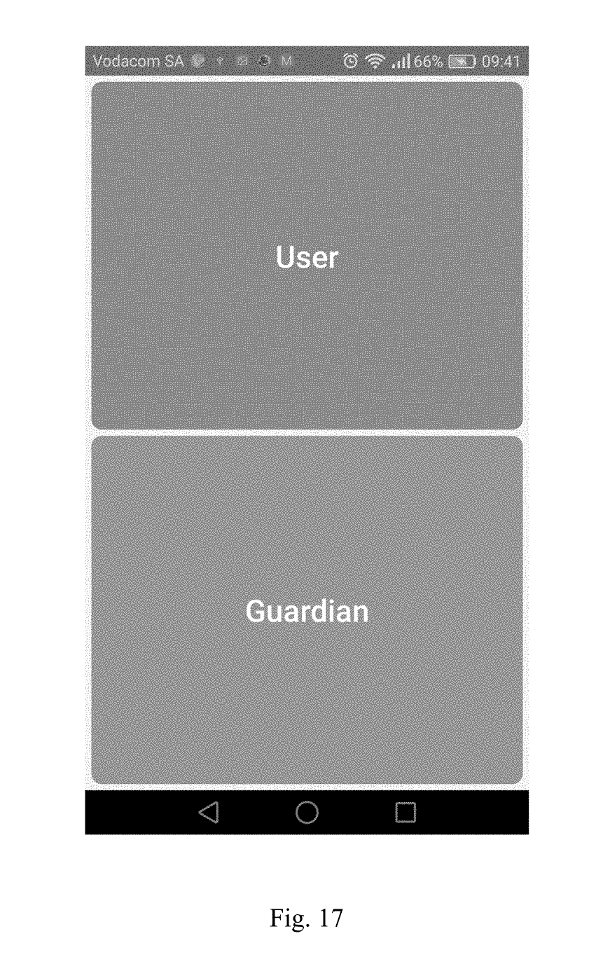

Referring to FIGS. 2A-G, exemplary user interactions are illustrated. In general, a user interacts with an application as described herein according to whether they are a user, or a guardian of another user. At 202, it is determined whether the current user is an ordinary user of a guardian. In some embodiments, this determination is based on the application configuration. An exemplary roles selection screen is provided in FIG. 17. This exemplary screen may be shown on first launch, and allows a user to select whether they are a guardian or dependent user.

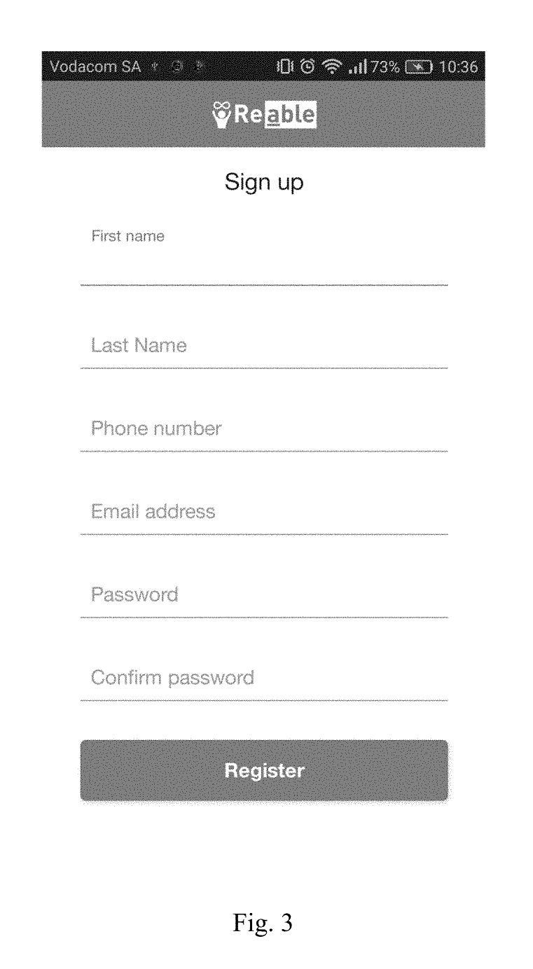

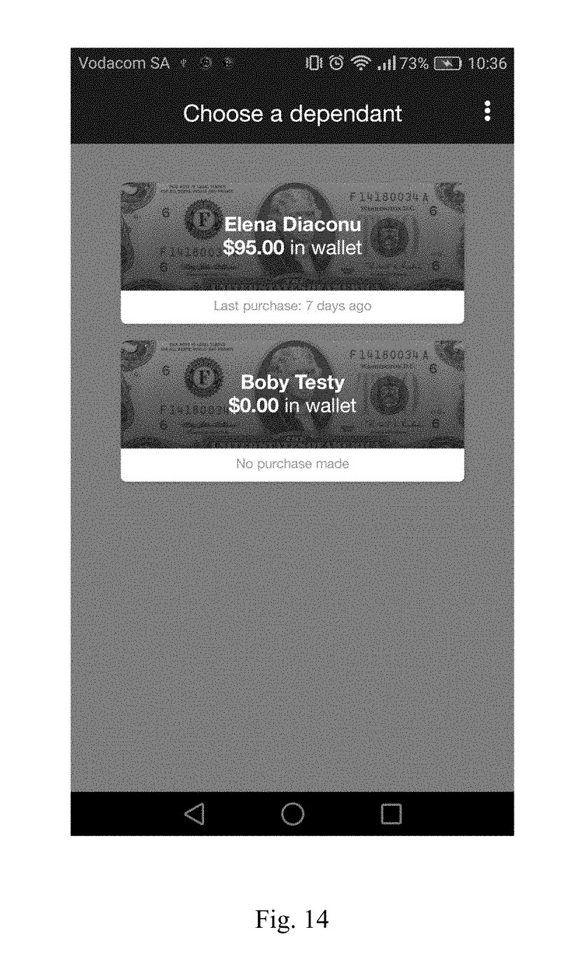

Referring to FIG. 2B, if the current user is a guardian, it is determined whether they have an account. If they do not have an account, a registration form is provided. An exemplary registration form is illustrated in FIG. 3. User input to the registration form is processed. If processing is not successful, an error message is displayed, and the registration for is again displayed. If registration is successful, a selection screen is displayed at 203, allowing selection of a child or other dependent. Exemplary dependent selection screens are provided in FIGS. 14-16.

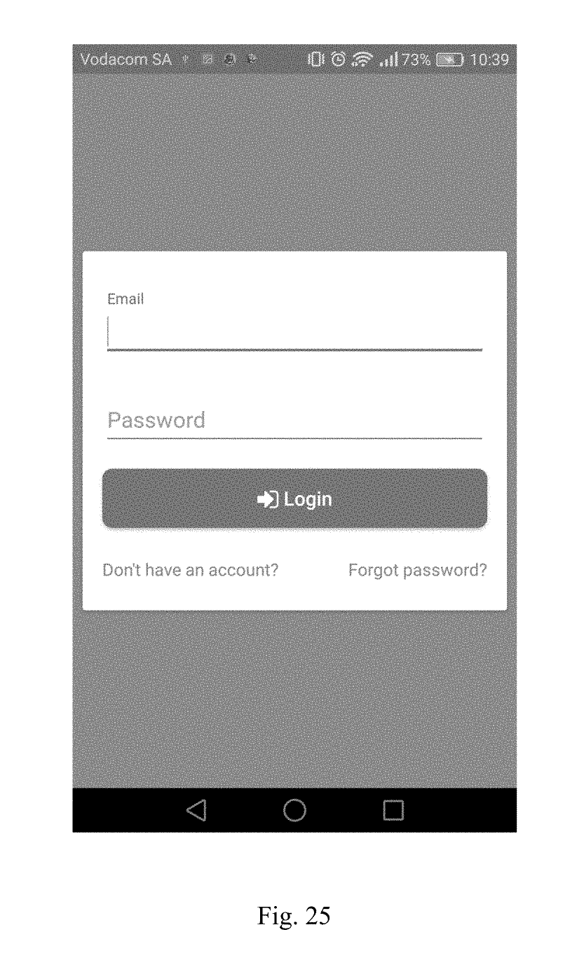

If a guardian has an account, a login screen is displayed. An exemplary login screen is shown in FIG. 25. If login is not successful, an error is displayed and the login screen is displayed again. If a login is successful, a selection screen is displayed at 203, allowing selection of a child or other dependent.

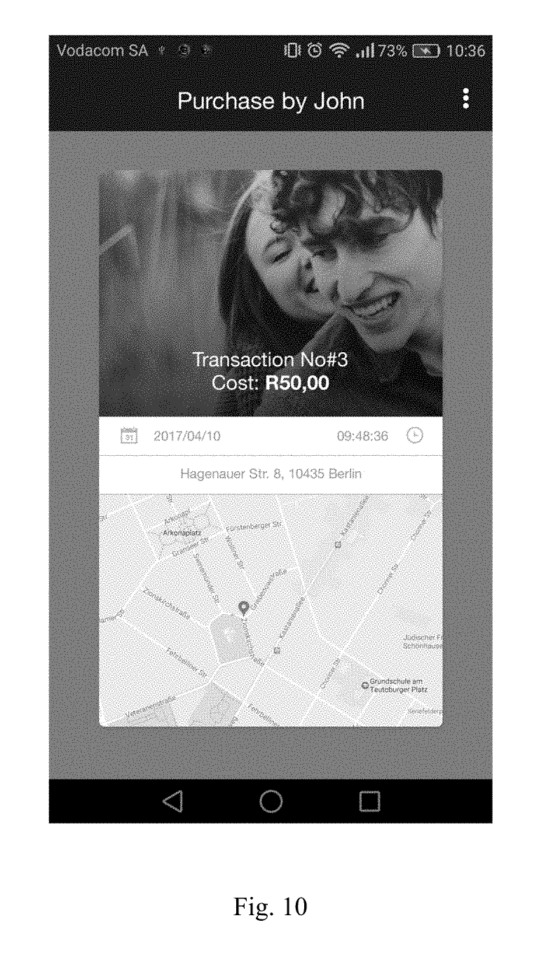

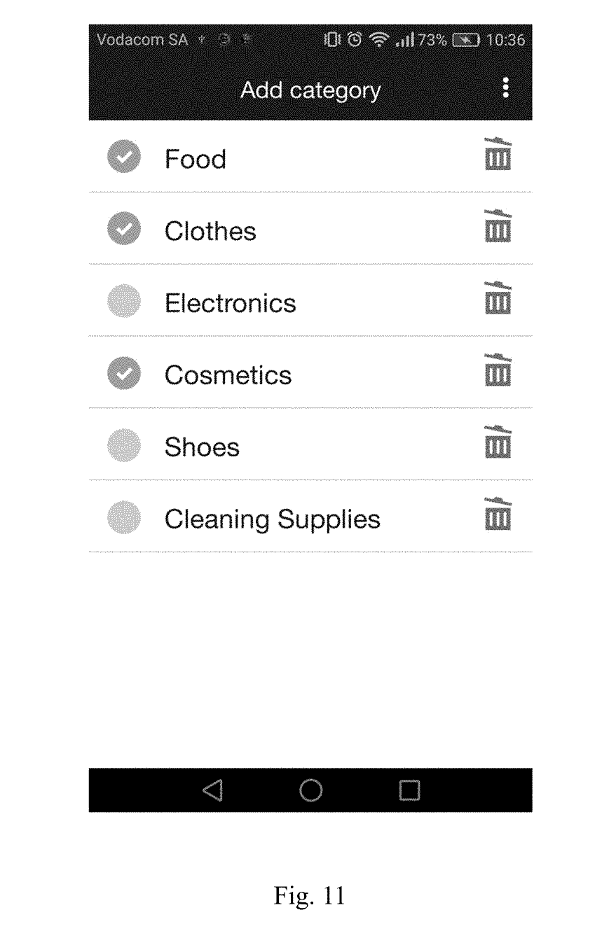

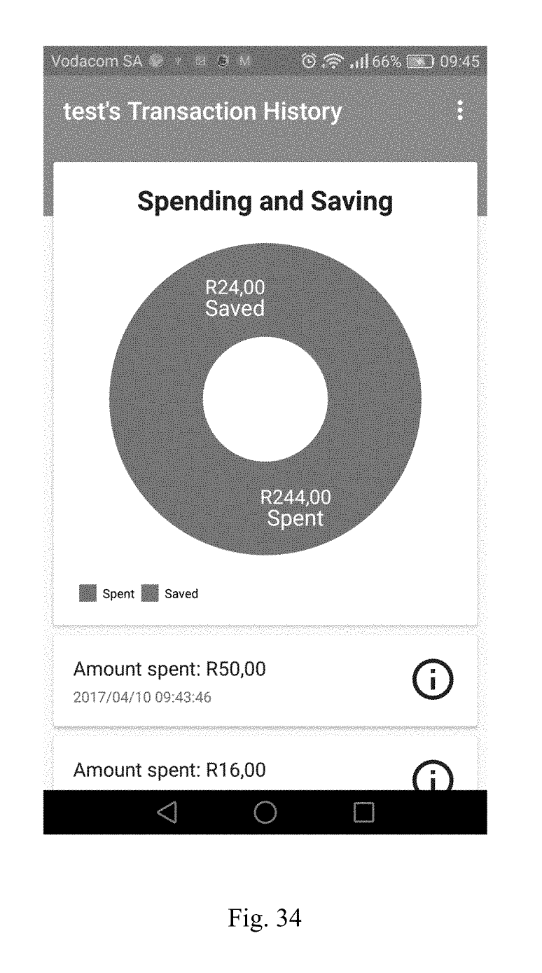

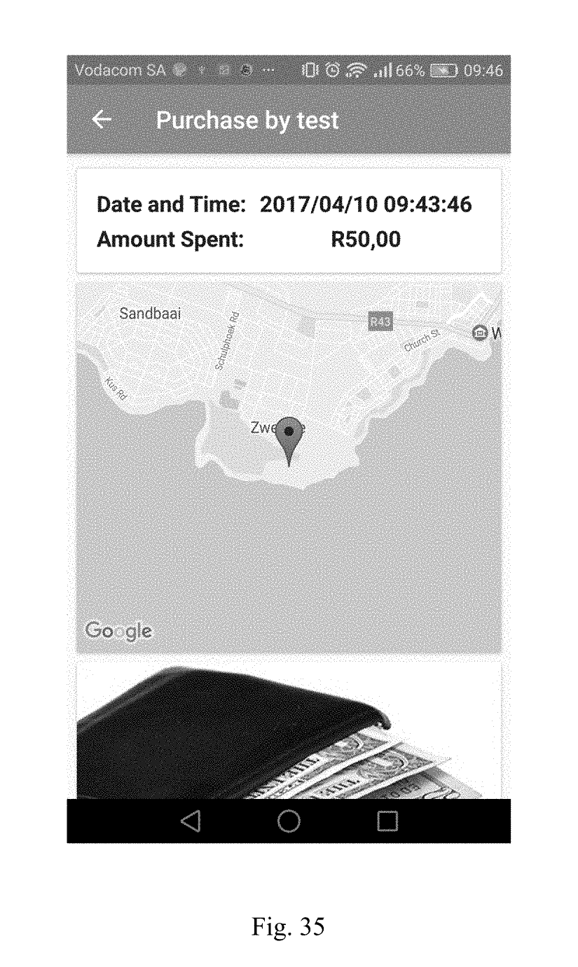

Referring to FIG. 2C, when an individual dependent is selected at 204, a list of transaction is displayed. The guardian may select a given transaction and details of that transaction are displayed. In some embodiments, the transaction details include geolocation. An exemplary transaction history screen is given in FIG. 34. An exemplary transaction detail view is provided in FIG. 10. Another exemplary transaction detail view is provided in FIG. 35, which includes a map indicative of transaction location.

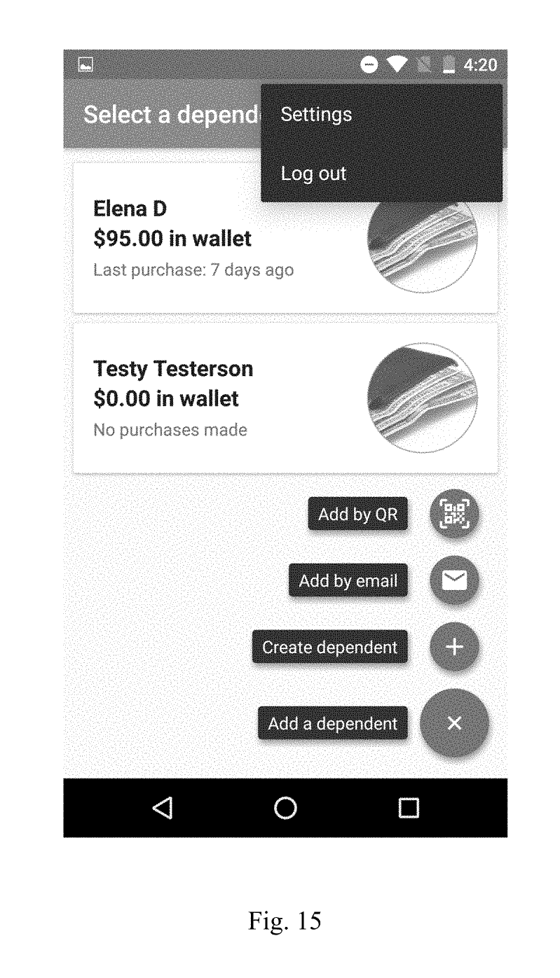

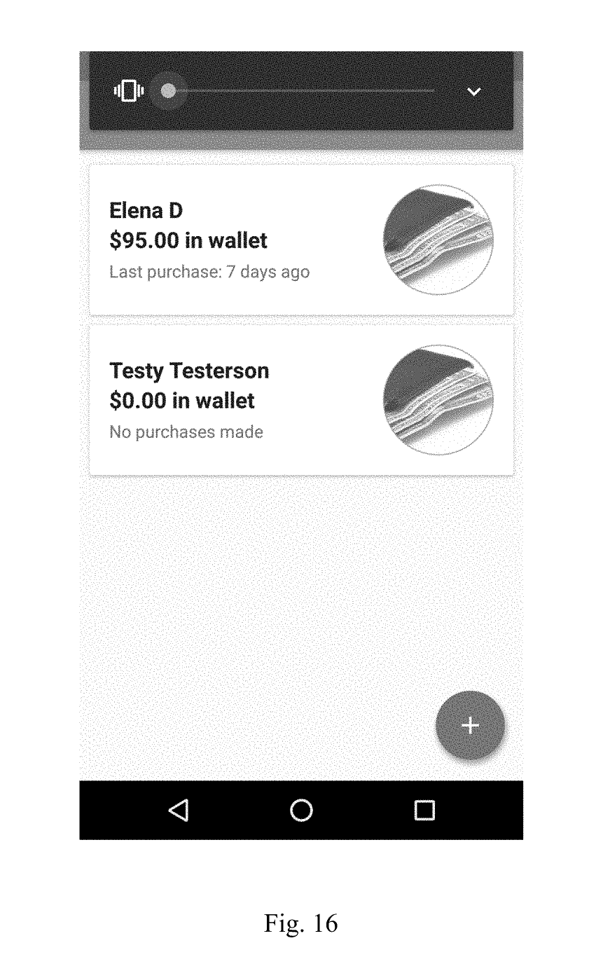

When a guardian activates a menu at 205 (which in some embodiments is a plus button), additional options are provided. An exemplary menu button is shown in FIG. 16. An expanded menu is illustrated in FIG. 15.

In various embodiments, additional dependents may be added by email. A guardian may enter an email, which if valid, results in the addition of a dependent for the given guardian, which is then displayed on the dependent selection screen at 206.

In various embodiments, additional dependents may be added by scanning a QR code provided by that dependent. A camera is accessed to capture a target QR code. If the QR code is valid, a dependent is added for the given guardian, which is then displayed on the dependent selection screen at 206.

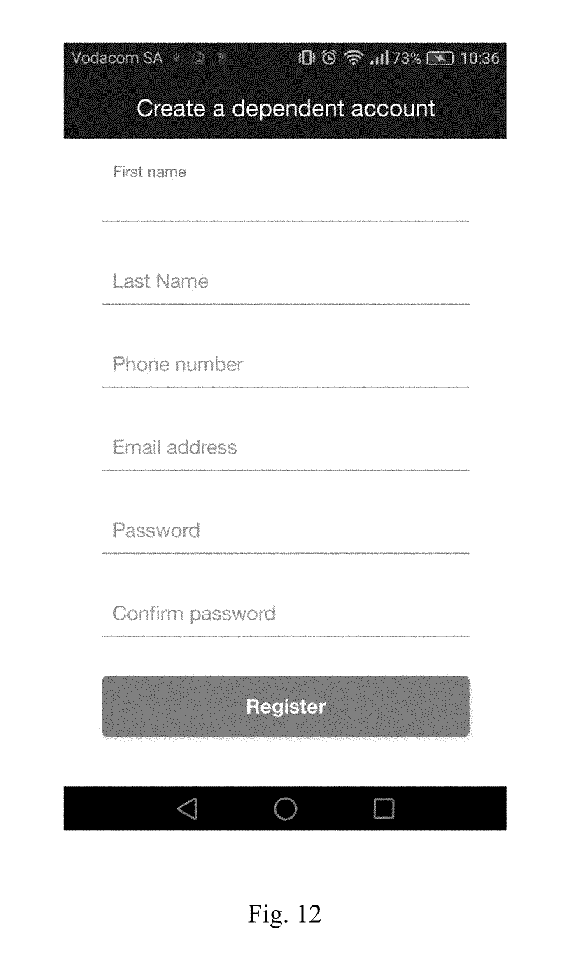

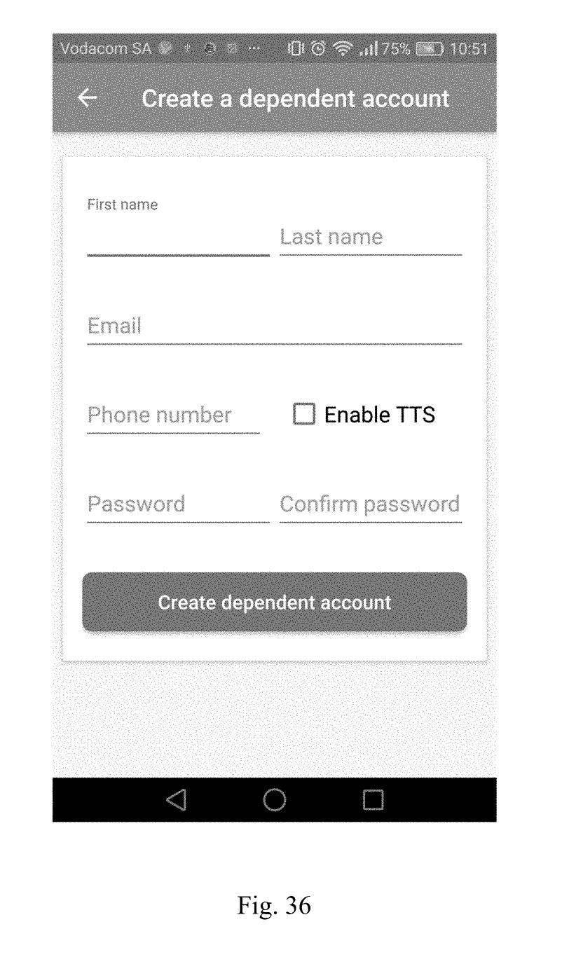

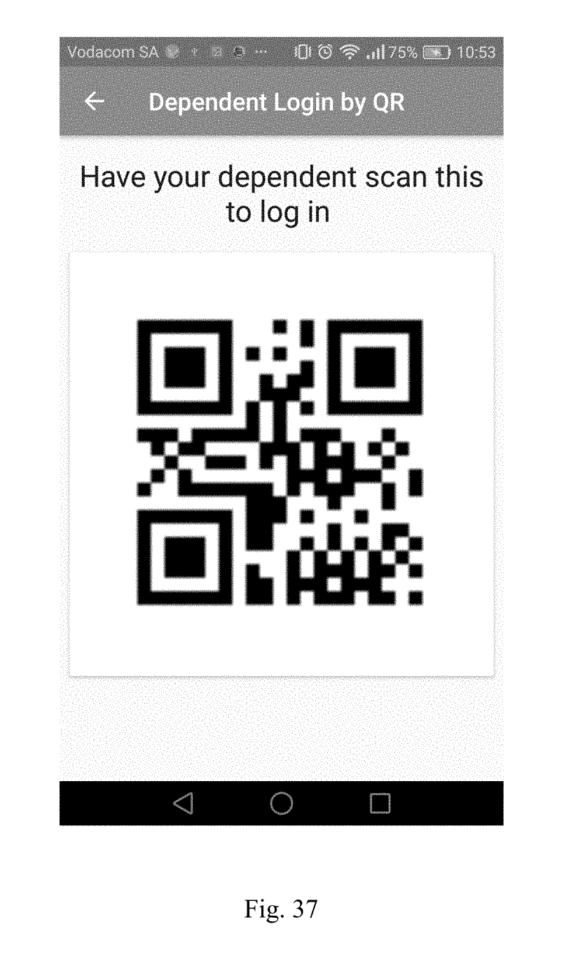

In various embodiments, a new dependent may be created by a guardian. A dependent registration screen is displayed. If the registration is successful, a dependent is added for the given guardian, which is then displayed on the dependent selection screen at 206. An exemplary account creation screen is given in FIGS. 12 and 36.

In various embodiments, a guardian may logout, which returns the app to a user selection or login screen.

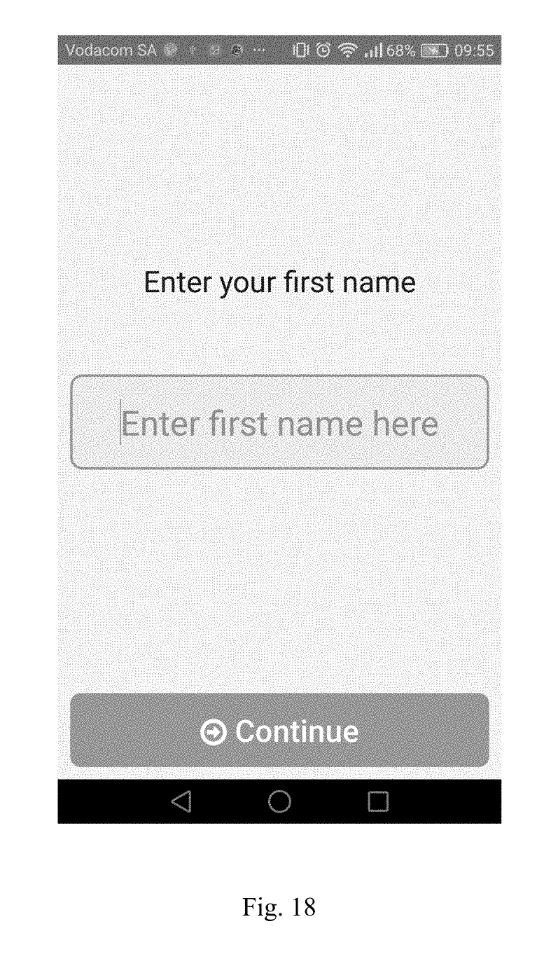

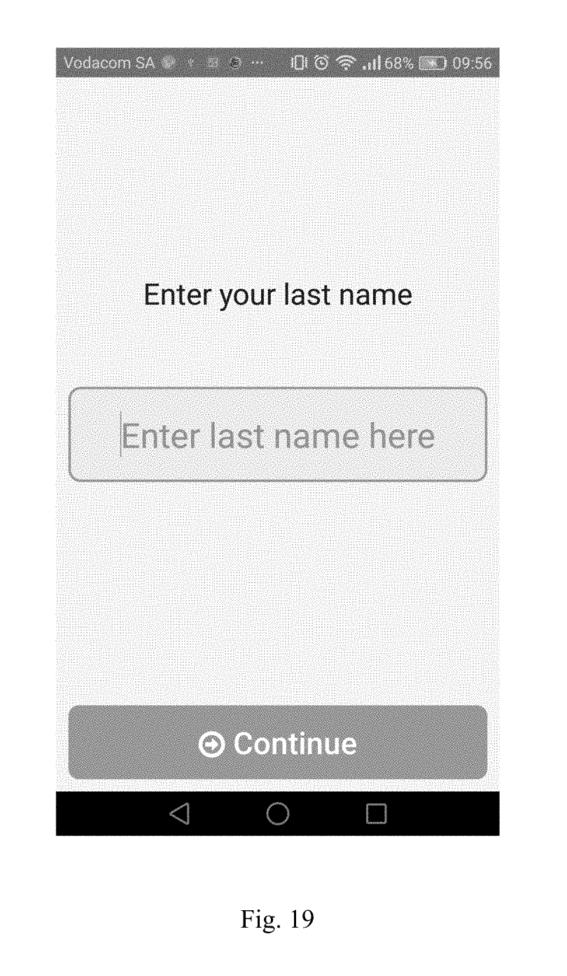

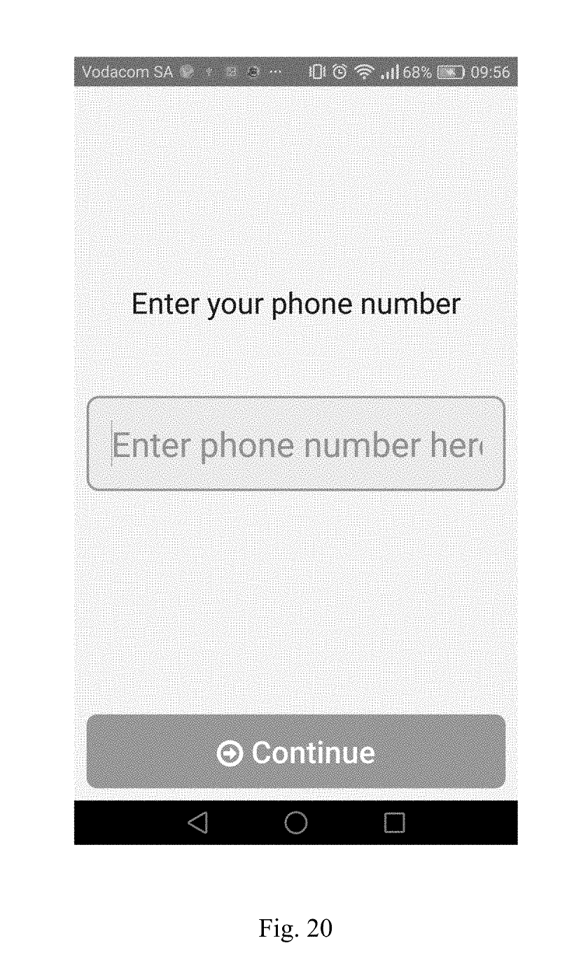

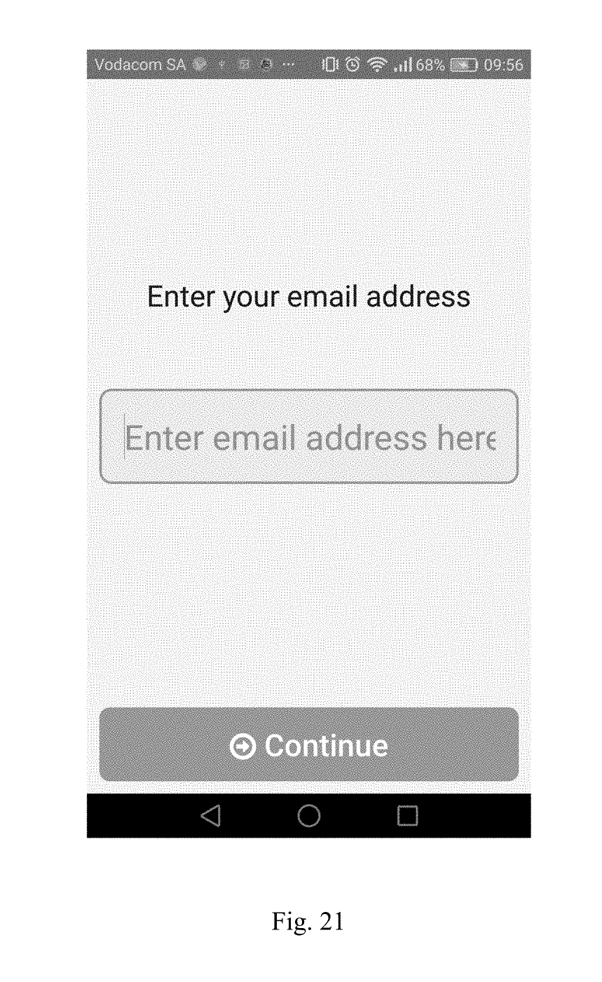

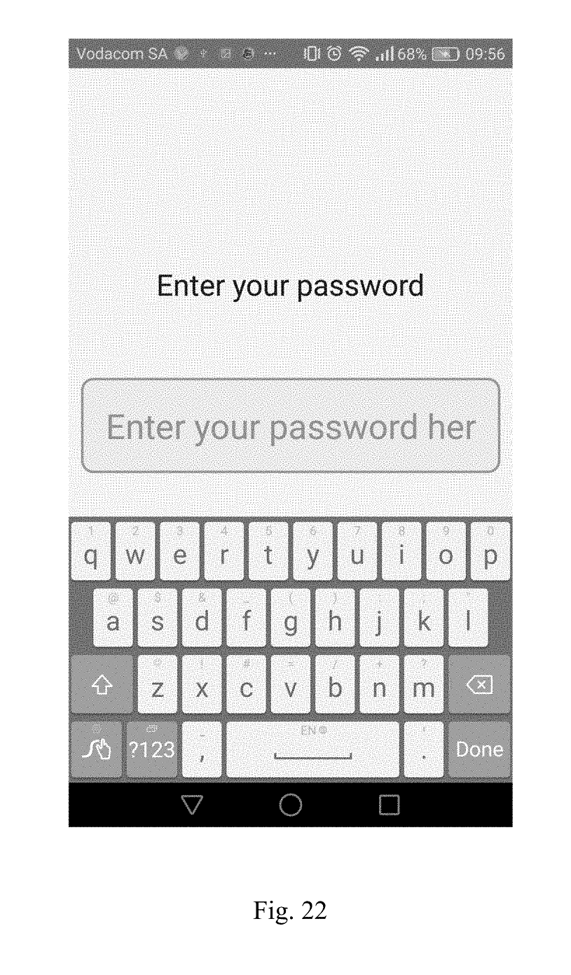

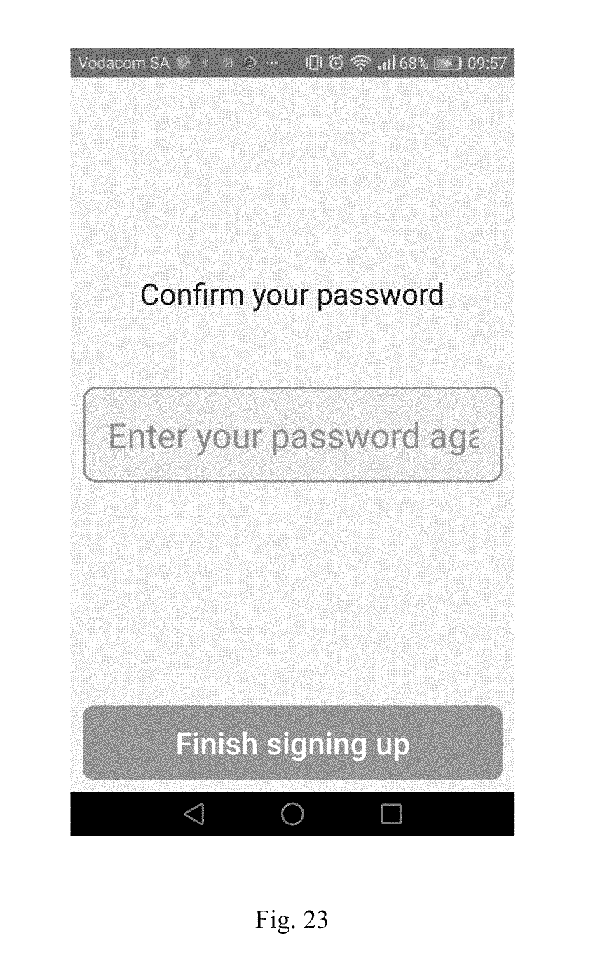

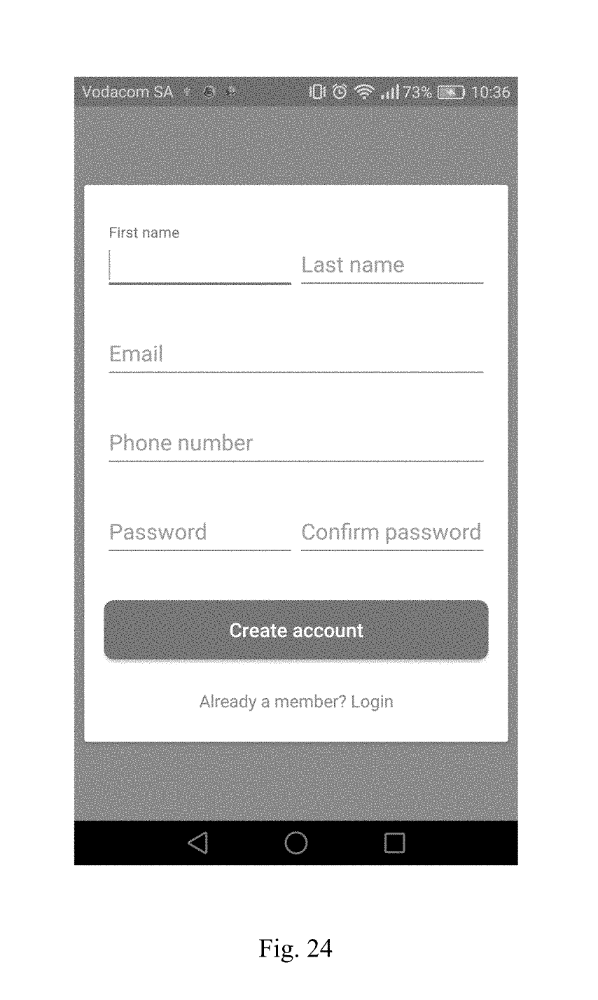

Referring back to FIG. 2A, if the current user is a dependent, it is determined whether they have an account. If they do not have an account, a registration form is provided. An exemplary registration form for a dependent is illustrated in FIG. 12. Alternatively, the multiple fields of the registration form may be spread out over multiple screens such as those in FIGS. 18-23. A further exemplary registration form is illustrated in FIG. 24. User input to the registration form is processed. If processing is not successful, an error message is displayed, and the registration form is again displayed. If registration is successful, a home screen is displayed at 207.

If a dependent has an account, a login screen is displayed. If login is not successful, an error is displayed and the login screen is displayed again. If a login is successful, a home screen is displayed at 207.

In some embodiments, a dependent may login by scanning a QR code on their guardian's phone, once the guardian has created their account. An exemplary login by QR screen is provided in Fig.

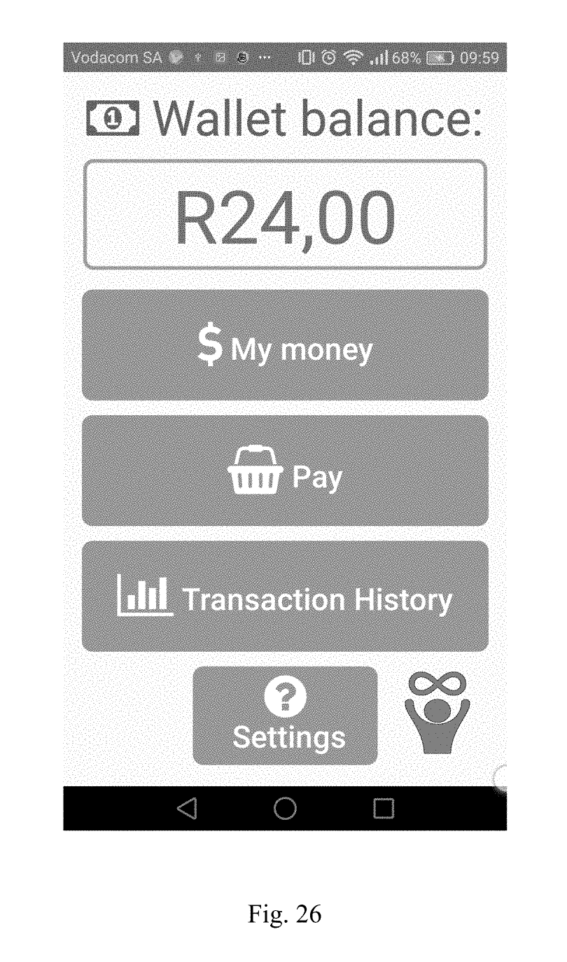

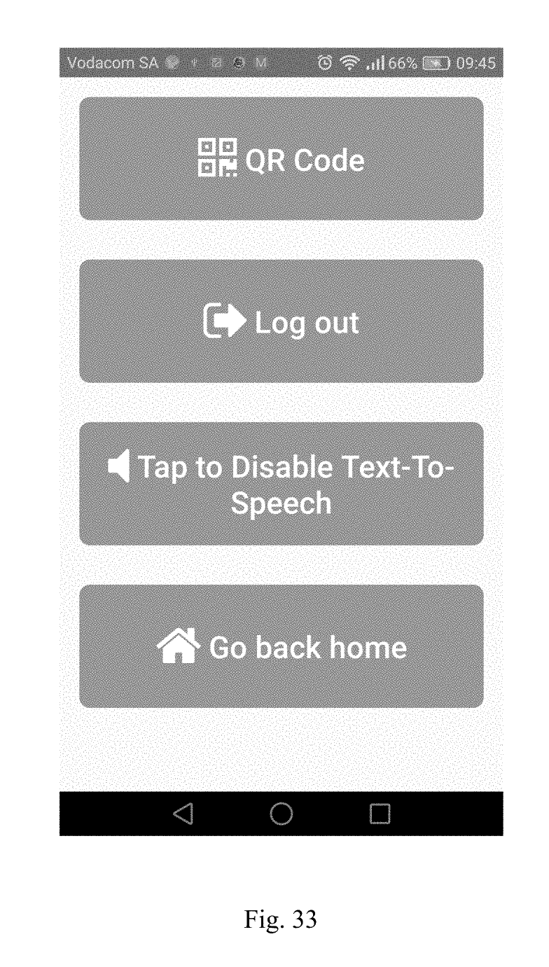

An exemplary home screen is depicted in FIG. 26. The home screen provides a preview of wallet balance and allows the user to travel across the application. In various embodiments, the home screen enables a user to see their balance, access their wallet, go to the payment screen, go to the transaction history screen, and view their settings. An exemplary settings screen is provided at FIG. 33.

Referring to FIG. 2D, when a dependent activates a menu at 208 (which in some embodiments is a more button), additional options are provided.

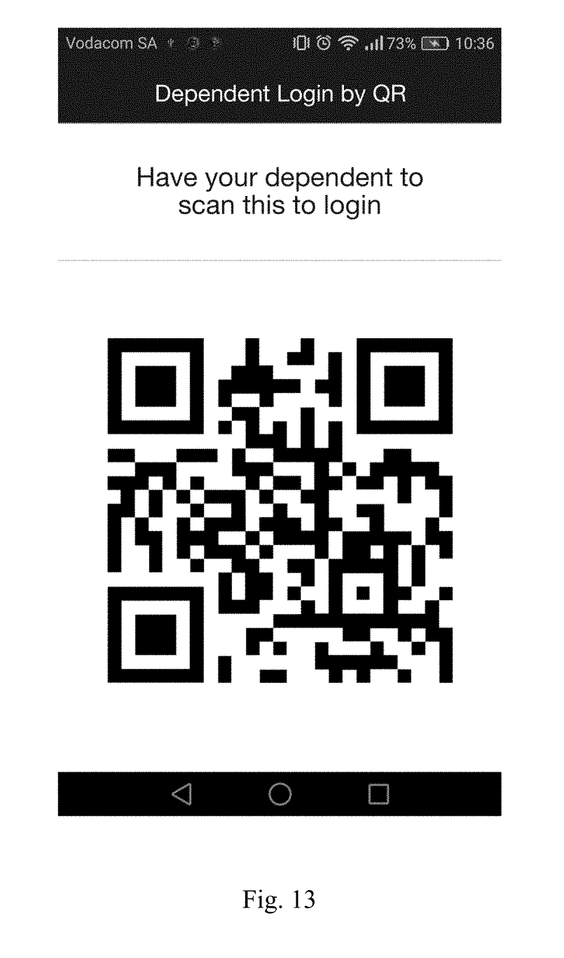

In various embodiments, a dependent may display a QR code for scanning by a guardian. In this way, an association may be made between a guardian and dependent account. An exemplary QR code is shown in FIG. 13.

In various embodiments, a dependent may logout, which returns the app to a user selection or login screen.

In various embodiments, a dependent may opt to enable text-to-speech. When text-to-speech is enabled, the various elements of the user interface are presented with speech queues.

Referring to FIG. 2E, various dependent money transactions are illustrated.

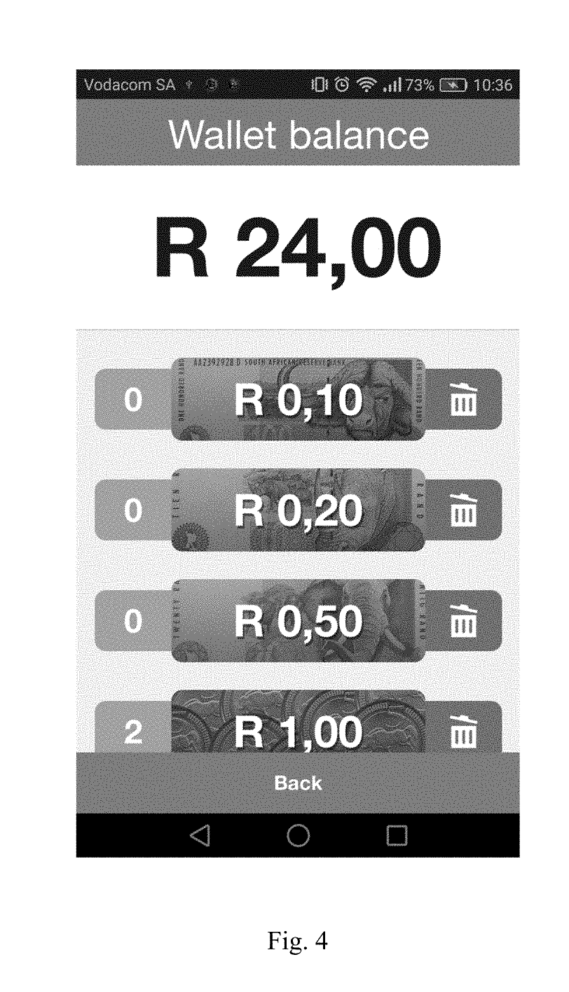

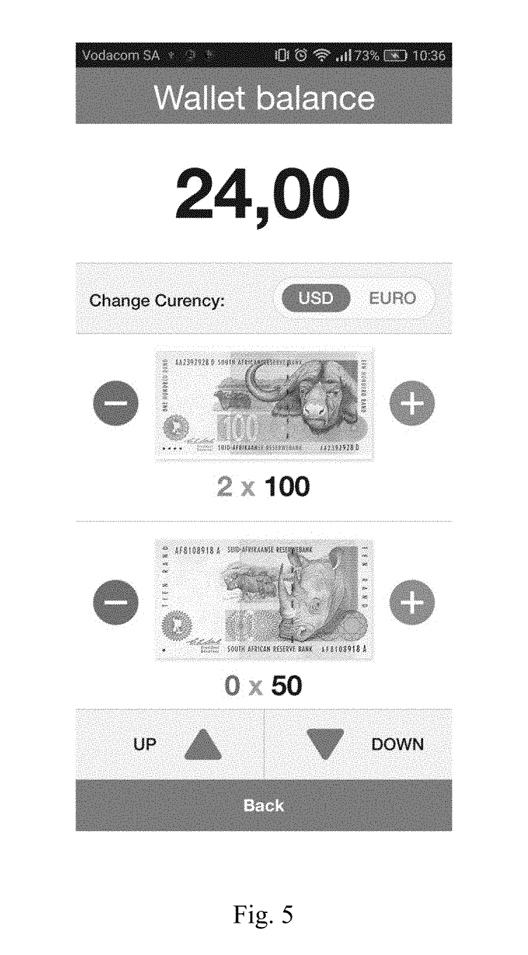

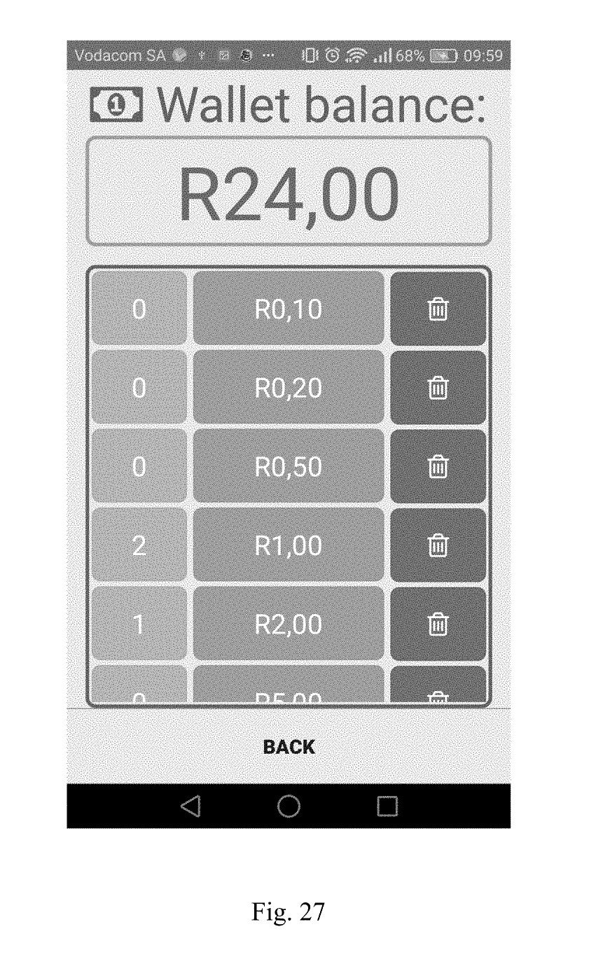

A dependent may select to view wallet contents. Exemplary wallet views are shown in FIGS. 4-5, and 27. A user may add bills to their wallet or otherwise adjust its contents. In various embodiments, the wallet view is tailored to the locality of the user, to show appropriate banknote images for easy identification.

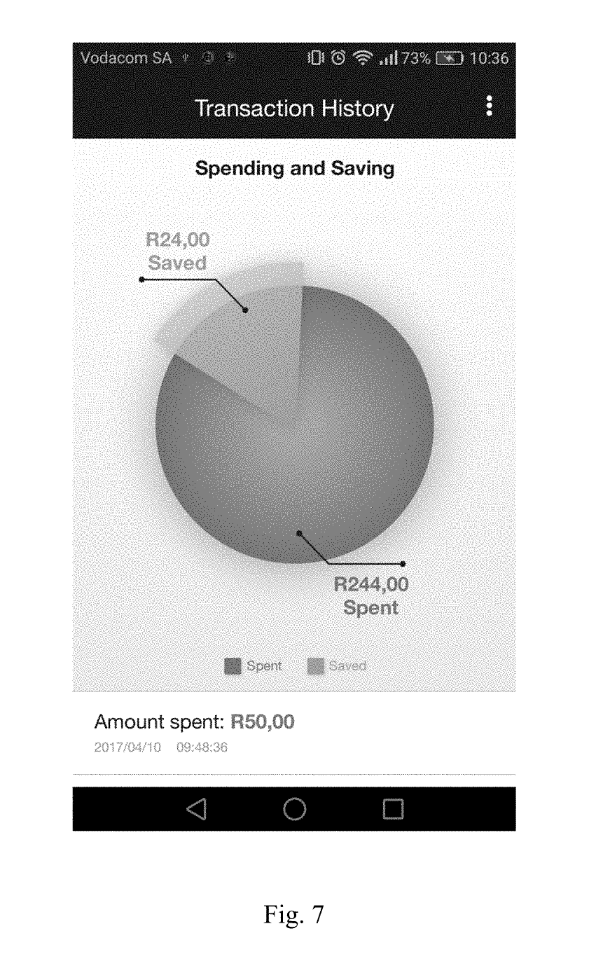

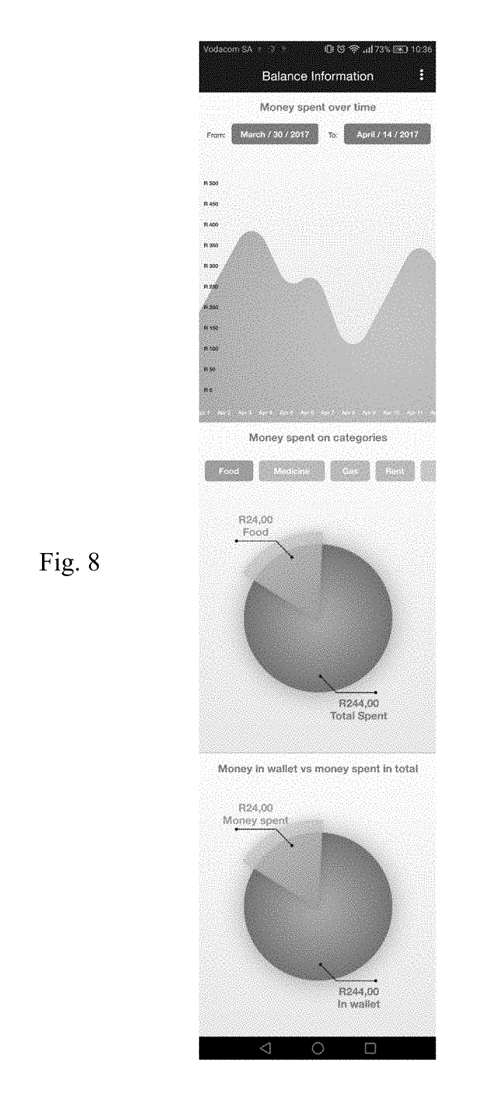

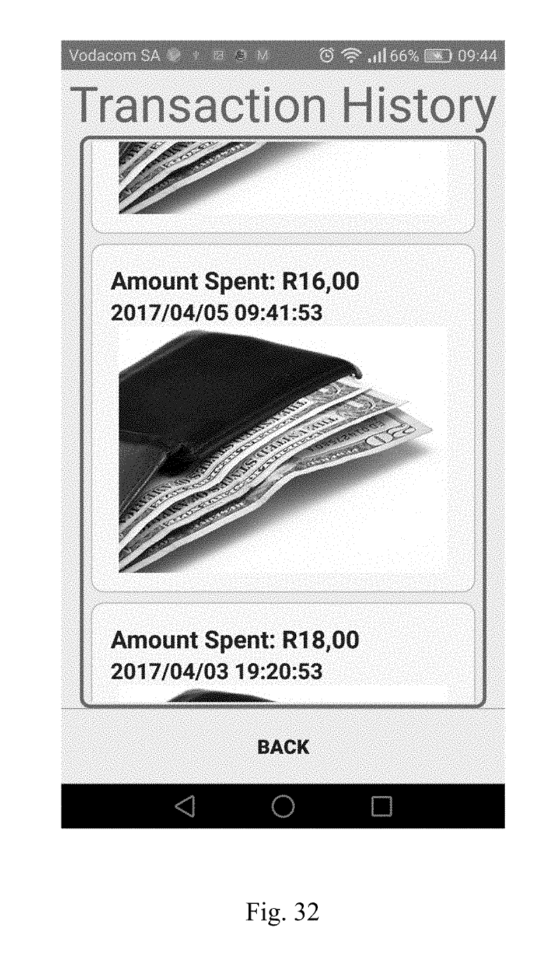

A dependent may select a transaction history to review a list of prior transactions. An exemplary history screen is provided in FIG. 32. An exemplary transaction summary is shown at FIG. 7. In various embodiments, additional transaction details may be provided, such as views of spending over time, or spending per category. Exemplary additional transaction detail is shown in FIG. 8. In various embodiments, charts are provided that include money spent over time with configurable time ranges, money spent on each category, money in wallet vs money spent in total.

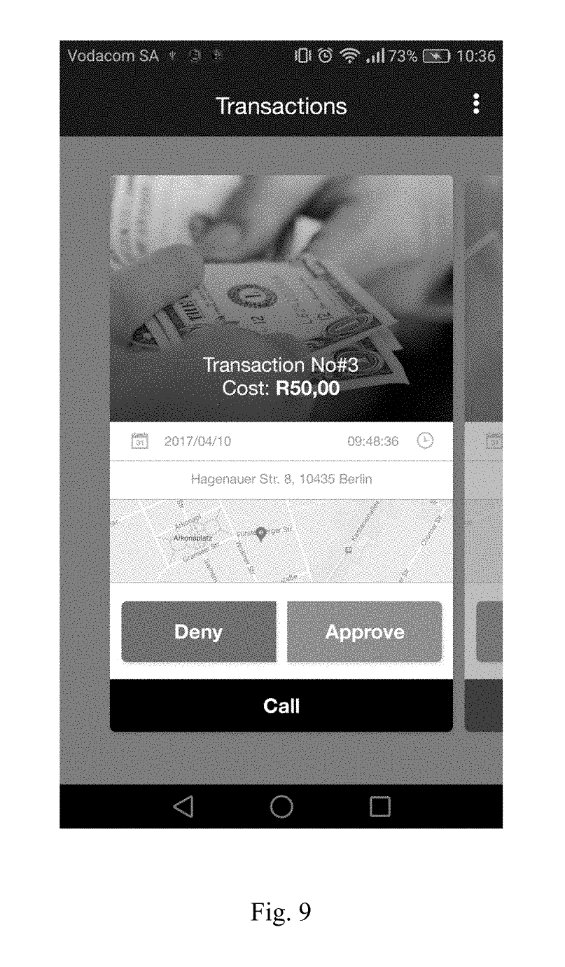

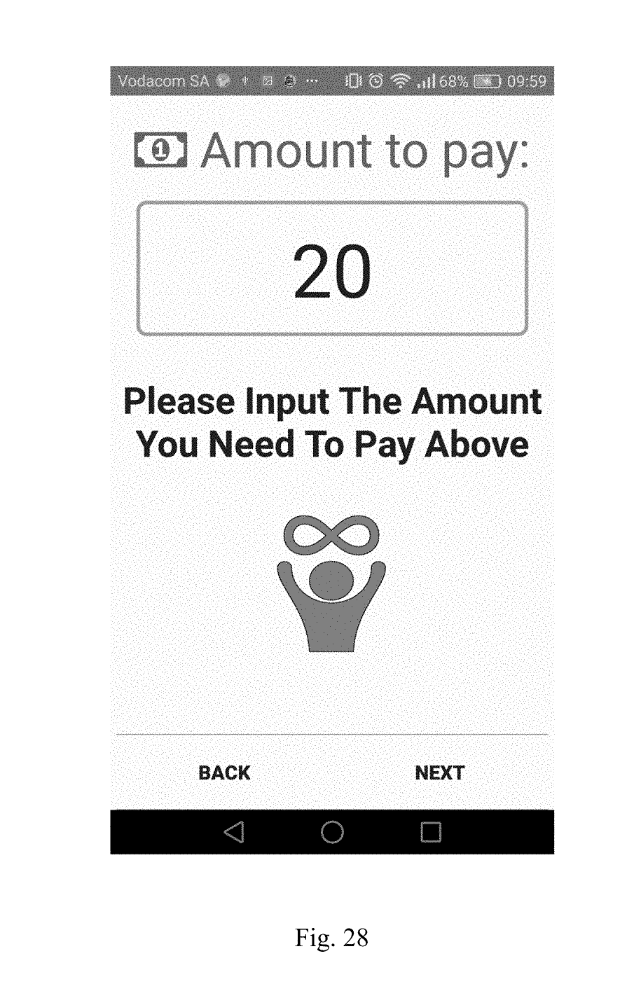

A dependent may initial a transaction. An exemplary payment screen is shown in FIG. 28, which prompts the user to enter the amount of money they need to pay. In various embodiments, the user is prompted to indicate a category for that transaction. In various embodiments, the user is asked to take a photo of the product to be purchased. In some embodiments, once a photo is taken, the user is asked to confirm that the photo is of the correct product. If an internet connection is available, a confirmation request is sent to a guardian. An exemplary confirmation request is shown in FIG. 9. In various embodiments, the confirmation screen includes the transaction cost, transaction time, transaction picture, transaction location, a deny button, an approve button, and/or a call button. In some embodiments, an awaiting confirmation screen is displayed to the user while waiting for guardian approval. In some embodiments, if confirmation is not received within a predetermined time limit, the transaction is declined and the user is returned to the home screen. When a response is received from the guardian, it is displayed to the dependent. If the response it a rejection of the transaction, further instructions are provided to the dependent, for example to call or text the guardian.

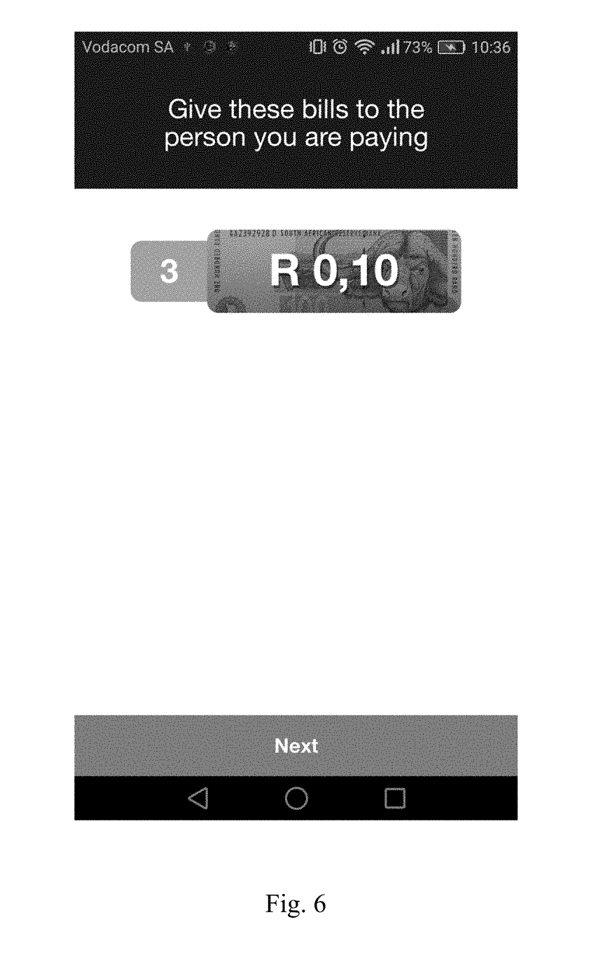

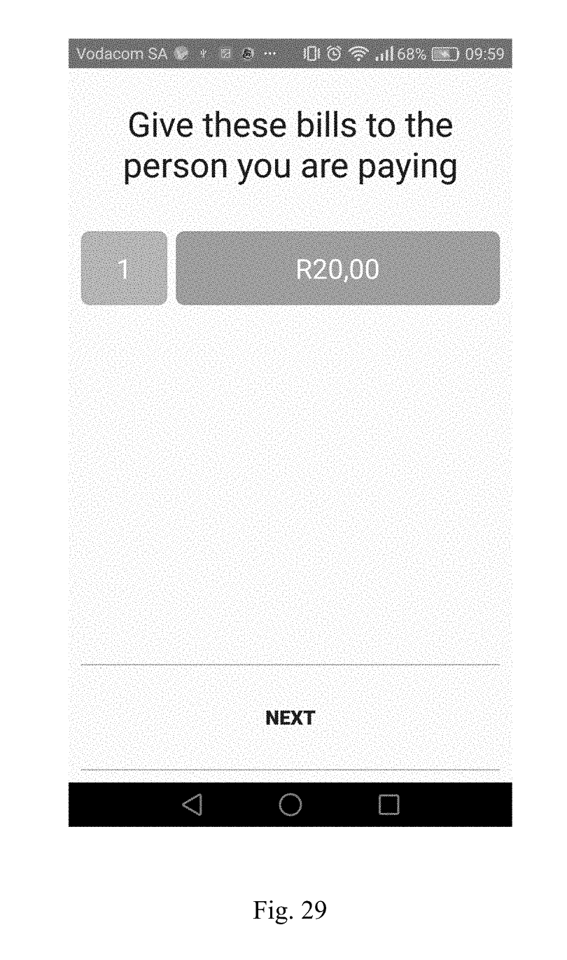

If there is no internet connection available, or the application is configured not to seek guardian approval, then each transaction is treated as approved. Referring to FIG. 2F, upon approval of a transaction, the dependent is walked through the transaction. In some embodiments, the user is prompted to enter the amount owed. The amount is checked against the amount of cash on hand. If the user has enough cash, they are prompted with payment instructions, which may include the number any type of bank notes to provide in payment. An exemplary instruction screen is given in FIGS. 6 and 29.

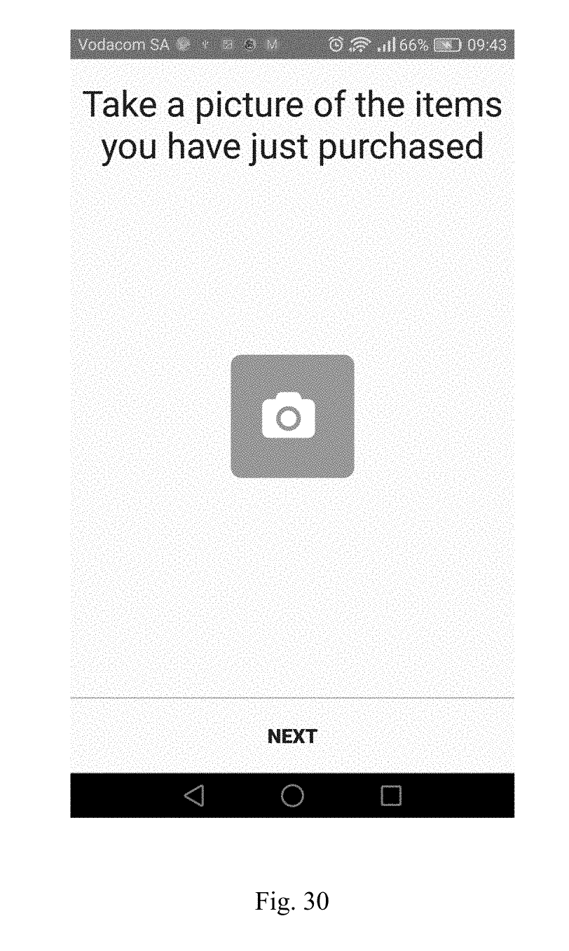

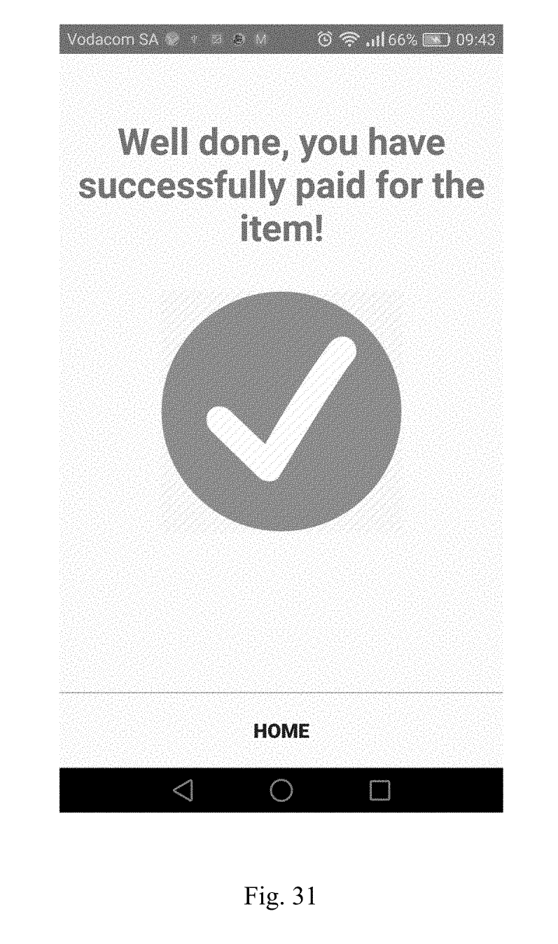

In cases where there is change, a user is prompted to enter the amount and type of change received. If the change does not reconcile, then the user is prompted to take further action. If all change is accounted for, or if there is no change, in some embodiments, the user is prompted to take a picture of the item purchased and to confirm that the photo is correct. An exemplary photo prompt screen is provided in FIG. 30. Once the transaction is confirmed, the user is returned to the home screen. In some embodiments, the user is shown a success screen after completing the transaction in order to indicate that the transaction is complete. An exemplary confirmations screen is provided in FIG. 31.

In various embodiments, user types may include persons with disabilities and their guardian. As described above, systems and methods according to the present disclosure assist users with disabilities to be financially independent.

Various disabilities maybe addressed according to the present disclosure. For users with cognitive disabilities or mental disabilities, the present disclosure assists with bill recognition and receipt recognition. For users with visual disabilities, embodiments of the present disclosure provide users interfaces having high contrast, black & white, or color inversion. Some embodiments provide large buttons, broad spacing, clearly separated keys, predictable key layouts, large and clear fonts, and large touch targets (e.g., 9×9 mm). Various embodiments provide magnifying features to further increase accessibility of the user interface.

Additional audio-based accessibility features are provided in some embodiments. For example, tones may be provided that change based on the area of navigation. Shake to undo functionality may be provided. Text-to-speech integration may be provided. Integration may also be provided with intelligent assistants such as Alexa. Vibration/haptic navigation feedback may be provided in some embodiments. Some embodiments provide a screen reader.

In some embodiments, notifications are provided through vibrations in additional to visual feedback. Some embodiments additionally provide flashing lights for notifications.

In some embodiments, voice navigation may be provided. In some embodiments, simple visual interfaces are provided that avoid the use of gestures, and thereby are more accessible to those with reduced dexterity. In some embodiments, a wearable case is provided to give support to the device. In some embodiments, eye tracking is used for application interaction.

It will be appreciated that various currencies in various denominations may be accommodated by systems according to the present disclosure. In various embodiments, systems are configurable with new currencies and corresponding denominations.

It will be appreciated that while various examples described herein are described with regard to a mobile app, the various interfaces described herein may be implemented as one or more web application.

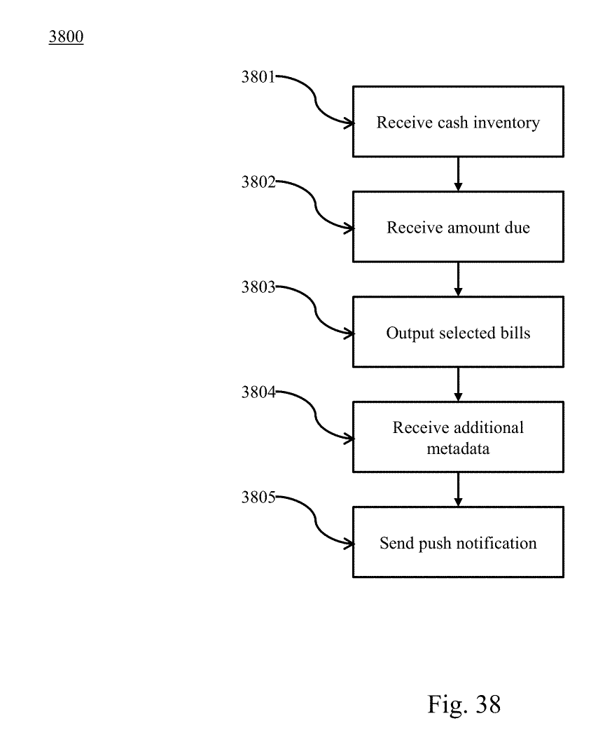

With reference now to FIG. 38, an exemplary method according to embodiments of the present disclosure is illustrated. At 3801, an inventory of bank notes is received at a mobile device. At 3802, an amount due is entered into the mobile device. At 3803, a combination of bills is output. In some embodiments, an amount of expected change is output. At 3804, additional metadata regarding the purchase is received. Metadata may include a category describing the purchase or a photo. At 3805, a push notification is sent to a second user.

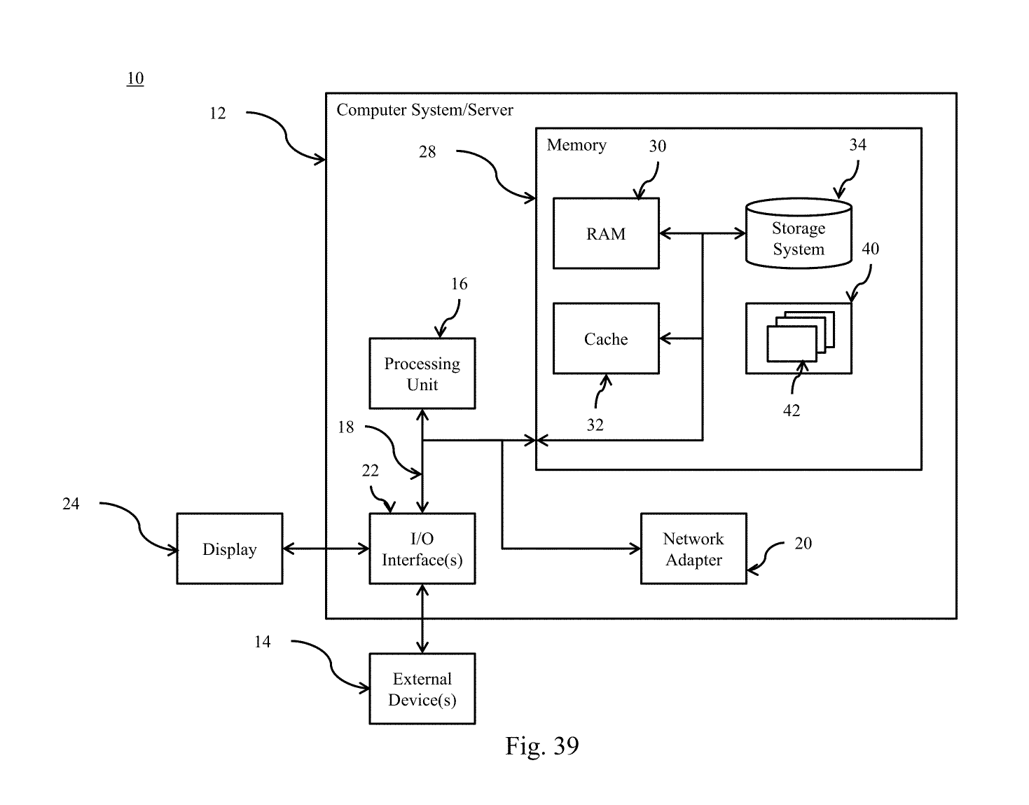

Referring now to FIG. 39, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving an inventory of bank notes at a mobile device;
receiving an amount due at the mobile device;
sending a push notification to a remote user, requesting approval of the amount due;
receiving from the remote user an approval of the amount due;
outputting from the mobile device a combination of bank notes suitable for payment of the amount due;
recording by the mobile device completed payment.

2. The method of claim 1, wherein receiving the inventor of bank notes comprises receiving user input to the mobile device.

3. The method of claim 1, wherein receiving the amount due comprises receiving user input to the mobile device.

4. The method of claim 1, wherein the push notification comprises the amount due.

5. The method of claim 1, wherein the push notification comprises a location of the mobile device.

6. The method of claim 1, wherein the push notification comprises a name of a user of the mobile device.

7. The method of claim 1, wherein the remote user is a guardian of a user of the mobile device.

8. The method of claim 1, further comprising:
capturing a picture of an item to be purchased by the mobile device.

9. The method of claim 8, wherein the push notification comprising the picture.

10. The method of claim 1, further comprising:
receiving an inventory of bank notes received as change from payment of the amount due;
reconciling by the mobile device the bank notes received as change.

11. A system comprising:
a mobile device comprising a computer readable storage medium having program instructions embodied therewith, the program instructions executable by a processor of the computing node to cause the processor to perform a method comprising:
receiving an inventory of bank notes;
receiving an amount due;
sending a push notification to a remote user, requesting approval of the amount due;
receiving from the remote user an approval of the amount due;
outputting a combination of bank notes suitable for payment of the amount due;
recording completed payment.

12. The system of claim 11, wherein receiving the inventor of bank notes comprises receiving user input to the mobile device.

13. The system of claim 11, wherein receiving the amount due comprises receiving user input to the mobile device.

14. The system of claim 11, wherein the push notification comprises the amount due.

15. The system of claim 11, wherein the push notification comprises a location of the mobile device.

16. The system of claim 11, wherein the push notification comprises a name of a user of the mobile device.

17. The system of claim 11, wherein the remote user is a guardian of a user of the mobile device.

18. The system of claim 11, the method further comprising:
capturing a picture of an item to be purchased by the mobile device.

19. The system of claim 18, wherein the push notification comprising the picture.

20. The system of claim 11, the method further comprising:
receiving an inventory of bank notes received as change from payment of the amount due;
reconciling by the mobile device the bank notes received as change.

21. A computer program product for cash transaction assistance, the computer program product comprising a computer readable storage medium having program instructions embodied therewith, the program instructions executable by a processor to cause the processor to perform a method comprising:
receiving an inventory of bank notes at a mobile device;
receiving an amount due at the mobile device;
sending a push notification to a remote user, requesting approval of the amount due;
receiving from the remote user an approval of the amount due;
outputting from the mobile device a combination of bank notes suitable for payment of the amount due;
recording by the mobile device completed payment.

22. The computer program product of claim 21, wherein receiving the inventor of bank notes comprises receiving user input to the mobile device.

23. The computer program product of claim 21, wherein receiving the amount due comprises receiving user input to the mobile device.

24. The computer program product of claim 21, wherein the push notification comprises the amount due.

25. The computer program product of claim 21, wherein the push notification comprises a location of the mobile device.

26. The computer program product of claim 21, wherein the push notification comprises a name of a user of the mobile device.

27. The computer program product of claim 21, wherein the remote user is a guardian of a user of the mobile device.

28. The computer program product of claim 21, the method further comprising:
capturing a picture of an item to be purchased by the mobile device.

29. The computer program product of claim 28, wherein the push notification comprising the picture.

30. The computer program product of claim 21, the method further comprising:
receiving an inventory of bank notes received as change from payment of the amount due;
reconciling by the mobile device the bank notes received as change.
